(19) United States
(12) Patent Application Publication
(10) Pub. No.: US 2026/0139973 A1
(43) Pub. Date: May 21, 2026

(54) CAPACITIVE SENSOR DETECTION CIRCUIT

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Masaru NAGAO, Nisshin-shi (JP)

(21) Appl. No.: 19/282,917

(22) Filed: Jul. 28, 2025

(30) Foreign Application Priority Data
Nov. 20, 2024 (JP) 2024-202465

(51) Int. Cl. G01D 5/241

(52) U.S. Cl. CPC G01D 5/2417

(57) ABSTRACT

A capacitive sensor detection circuit has a sensor element with a displaceable electrode, a first electrode, and a second electrode. The circuit includes a signal generation circuit that provides a modulated signal to the displaceable electrode. A fully differential amplifier is included, with input terminals connected to the first and second electrodes and output terminals for first and second output signals. The circuit has feedback capacitors between the amplifier's input and output terminals, and capacitors between the electrodes and the amplifier's input terminals. A calculation circuit is included to process the amplifier's output signals. A controller acquires the first and second output signals and, in response, provides a feedback signal. This feedback signal is supplied through the input capacitors, has the same frequency but opposite phase as the modulated signal, and is determined based on the acquired output signals.

### CROSS REFERENCE TO RELATED APPLICATION

This application is based on Japanese Patent Application No. 2024-202465 filed on Nov. 20, 2024, the disclosure of which is incorporated herein by reference.

### TECHNICAL FIELD

The present disclosure relates to a capacitive sensor detection circuit.

### BACKGROUND

A detection circuit for a capacitive sensor may detect acceleration based on a change in capacitance that varies with the displacement of an electrode. This detection circuit may include: a fully differential amplifier that outputs a signal varying with a change in capacitance; and a feedback amplifier that controls the input voltage of the fully differential amplifier to a predetermined voltage.

### SUMMARY

According to an aspect of the present disclosure, a capacitive sensor detection unit is adapted to a sensor element. The capacitive sensor detection circuit may include a signal generation circuit, a fully differential amplifier, a first feedback capacitor, a second feedback capacitor, a calculation circuit, a first capacitor, a second capacitor, and a controller. The sensor element includes a displaceable electrode, a first electrode and a second electrode. The first electrode outputs a signal that varies with a change in a first capacitance between the displaceable electrode and the first electrode due to displacement of the displaceable electrode. The second electrode outputs a signal that varies with a change in a second capacitance between the displaceable electrode and the second electrode due to the displacement of the displaceable electrode. The signal generation circuit outputs a modulated signal to the displaceable electrode, and the modulated signal has an input amplitude, a frequency, and a phase. The fully differential amplifier includes a first input terminal, a second input terminal, a first output terminal, and a second output terminal. The first input terminal is connected to the first electrode. The second input terminal is connected to the second electrode. The first output terminal outputs a first output signal that varies with a change in a first input signal and a second input signal. The first input signal is provided to the first input terminal, and the second input signal is provided to the second input terminal. The second output terminal outputs a second output signal that varies with a change in the first input signal and the second input signal. The first feedback capacitor is connected to the first input terminal and the first output terminal, and the second feedback capacitor is connected to the second input terminal and the second output terminal. The calculation circuit outputs a value that correlates with the displacement of the displaceable electrode, based on the first output signal and the second output signal. The first capacitor is connected to a node between the first electrode and the first input terminal, and the second capacitor is connected to a node between the second electrode and the second input terminal. The controller acquires the first input signal and the second input signal, and outputs an inverted-phase signal to the first capacitor and the second capacitor based on the first input signal and the second input signal. Each of the first input signal and the second input signal may have a frequency and a phase corresponding to the frequency and the phase of the modulated signal. The inverted-phase signal may have: a feedback amplitude that adjusts an amplitude of each of the first input signal and the second input signal towards zero; a frequency that corresponds to the frequency of the modulated signal; and a phase that is opposite to the phase of the modulated signal.

### BRIEF DESCRIPTION OF DRAWINGS

FIG. 1 is a configuration diagram of a sensor element in which a capacitive sensor detection circuit according to the first embodiment is used.

FIG. 2 is a circuit diagram of the capacitive sensor detection circuit.

FIG. 3 is a diagram showing a modulated signal from a signal generator of the capacitive sensor detection circuit.

FIG. 4 is a diagram showing an output common-mode feedback circuit of a fully differential amplifier in the capacitive sensor detection circuit.

FIG. 5 is a block diagram of a controller of the capacitive sensor detection circuit.

FIG. 6 is a circuit diagram of the controller.

FIG. 7 is a diagram showing the signal output from the controller.

FIG. 8 is a circuit diagram of the controller in the capacitive sensor detection circuit according to the second embodiment.

FIG. 9 is a circuit diagram of the capacitive sensor detection circuit according to the third embodiment.

FIG. 10 is a diagram showing the input common-mode feedback circuit of the fully differential amplifier in the capacitive sensor detection circuit according to the fourth embodiment.

FIG. 11 is a circuit diagram of the capacitive sensor detection circuit.

FIG. 12 is a circuit diagram of the controller of the capacitive sensor detection circuit.

FIG. 13 is a circuit diagram of the controller in the capacitive sensor detection circuit according to the fifth embodiment.

FIG. 14 is a circuit diagram of the capacitive sensor detection circuit according to the sixth embodiment.

### DETAILED DESCRIPTION

In a comparative detection circuit, an input voltage of a fully differential amplifier is reset because a feedback amplifier may set an input voltage of the fully differential amplifier to a predetermined voltage. While the input voltage of the fully differential amplifier is being reset, the signal output from the fully differential amplifier may not contain a signal corresponding to the acceleration, resulting in a temporally discontinuous signal.

According to a first aspect of the present disclosure, a capacitive sensor detection circuit is adapted to a sensor element. The capacitive sensor detection circuit includes a signal generation unit, a fully differential amplifier, a first feedback capacitor, a second feedback capacitor, a calculation circuit, a first capacitor, a second capacitor, and a controller. The sensor element includes a displaceable electrode, a first electrode and a second electrode. The first electrode outputs a signal that varies with a change in a first capacitance between the displaceable electrode and the first electrode due to displacement of the displaceable electrode. The second electrode outputs a signal that varies with a change in a second capacitance between the displaceable electrode and the second electrode due to the displacement of the displaceable electrode. The signal generation unit outputs a modulated signal to the displaceable electrode, and the modulated signal has an input amplitude, a frequency, and a phase. The fully differential amplifier includes a first input terminal, a second input terminal, a first output terminal, and a second output terminal. The first input terminal is connected to the first electrode. The second input terminal is connected to the second electrode. The first output terminal outputs a first output signal that varies with a change in a first input signal and a second input signal. The first input signal is provided to the first input terminal, and the second input signal is provided to the second input terminal. The second output terminal outputs a second output signal that varies with a change in the first input signal and the second input signal. The first feedback capacitor is connected to the first input terminal and the first output terminal, and the second feedback capacitor is connected to the second input terminal and the second output terminal. The calculation unit outputs a value that correlates with the displacement of the displaceable electrode, based on the first output signal and the second output signal. The first capacitor is connected to a node between the first electrode and the first input terminal, and the second capacitor is connected to a node between the second electrode and the second input terminal. The controller acquires the first input signal and the second input signal, and outputs an inverted-phase signal to the first capacitor and the second capacitor based on the first input signal and the second input signal. Each of the first input signal and the second input signal has a frequency and a phase corresponding to the frequency and the phase of the modulated signal. The inverted-phase signal has: a feedback amplitude that adjusts an amplitude of each of the first input signal and the second input signal towards zero; a frequency that corresponds to the frequency of the modulated signal; and a phase that is opposite to the phase of the modulated signal.

According to a second aspect of the present disclosure, a capacitive sensor detection circuit is adapted to a sensor element. The capacitive sensor detection circuit includes a signal generation unit, a fully differential amplifier, a first feedback capacitor, a second feedback capacitor, a calculation unit, a first capacitor, a second capacitor, and a controller. The sensor element includes a displaceable electrode, a first electrode and a second electrode. The first electrode outputs a signal that varies with a change in a first capacitance between the displaceable electrode and the first electrode due to displacement of the displaceable electrode. The second electrode outputs a signal that varies with a change in a second capacitance between the displaceable electrode and the second electrode due to the displacement of the displaceable electrode. The signal generation unit outputs a modulated signal to the displaceable electrode, and the modulated signal has an input amplitude, a frequency, and a phase. The fully differential amplifier includes a first input terminal, a second input terminal, a first output terminal, and a second output terminal. The first input terminal is connected to the first electrode. The second input terminal is connected to the second electrode. The first output terminal outputs a first output signal that varies with a change in a first input signal and a second input signal. The first input signal is provided to the first input terminal, and the second input signal is provided to the second input terminal. The second output terminal outputs a second output signal that varies with a change in the first input signal and the second input signal. The first feedback capacitor is connected to the first input terminal and the first output terminal, and the second feedback capacitor is connected to the second input terminal and the second output terminal. The calculation unit outputs a value that correlates with the displacement of the displaceable electrode, based on the first output signal and the second output signal. The first capacitor is connected to a node between the first electrode and the first input terminal, and the second capacitor is connected to a node between the second electrode and the second input terminal. The controller acquires the first output signal and the second output signal, and outputs an inverted-phase signal to the first capacitor and the second capacitor based on the first output signal and the second output signal. Each of the first output signal and the second output signal has a frequency and a phase corresponding to the frequency and the phase of the modulated signal. The inverted-phase signal has: a feedback amplitude that adjusts an amplitude of each of the first output signal and the second output signal towards zero; a frequency that corresponds to the frequency of the modulated signal; and a phase that is opposite to the phase of the modulated signal.

As a result, the amplitudes of the first input signal and the second input signal, whose frequency and phase correspond to those of the modulated signal, continuously approach zero. Therefore, it is no longer necessary to provide a reset period for the first input signal and the second input signal. Accordingly, the output signals from the fully differential amplifier, which are output signals corresponding to changes in the first electrostatic capacitance and the second electrostatic capacitance, become signals that are continuous with respect to time.

It should be noted that the reference numerals in parentheses assigned to each component indicate merely one example of the correspondence between the respective components and the specific components described in the embodiments below.

Several embodiments will be described below with reference to the drawings. In the following embodiments, parts that are identical or equivalent to each other are denoted by the same reference numerals, and their detailed descriptions are omitted.

### First Embodiment

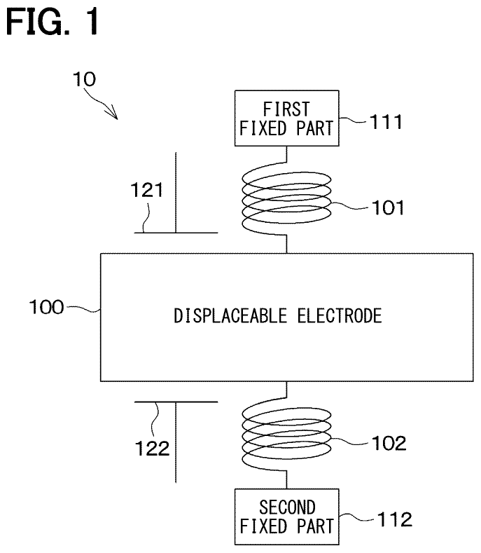

A capacitive sensor detection circuit according to the present embodiment is used with a sensor element 10 as shown in FIG. 1, and converts an output signal corresponding to a change in capacitance into a signal that is continuous with respect to time. First, the sensor element 10 will be described.

The sensor element 10 includes a displaceable electrode 100, a first elastic part 101, a first fixed part 111, a second elastic part 102, a second fixed part 112, a first electrode 121, and a second electrode 122.

The displaceable electrode 100 is displaced when subjected to acceleration or pressure. One end of the first elastic part 101 is connected to the displaceable electrode 100 in the direction in which the displaceable electrode 100 is displaced. The other end of the first elastic part 101 is connected to the first fixed part 111 in the direction in which the displaceable electrode 100 is displaced. The first fixed part 111 is secured to a housing or the like (not shown). One end of the second elastic part 102 is connected to the side of the displaceable electrode 100 opposite to the first elastic part 101, in the direction in which the displaceable electrode 100 is displaced. The other end of the second elastic part 102 is connected to the second fixed part 112 in the direction in which the displaceable electrode 100 is displaced. The second fixed part 112 is secured to a housing or the like (not shown). Accordingly, when the displaceable electrode 100 is displaced, the first elastic part 101 and the second elastic part 102 generate a restoring force by undergoing elastic deformation. Due to this restoring force, the position of the displaced displaceable electrode 100 returns to its original position.

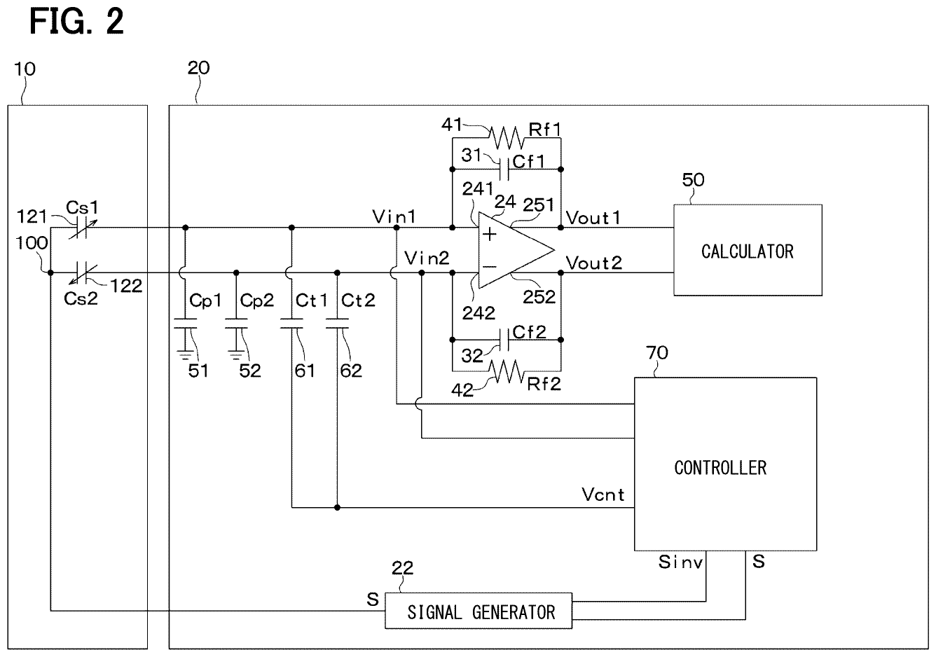

The first electrode 121 faces, in the direction in which the displaceable electrode 100 is displaced, the portion of the displaceable electrode 100 that is connected to the first elastic part 101. Further, when the displaceable electrode 100 is displaced, the distance between the first electrode 121 and the displaceable electrode 100 changes, resulting in a change in the first capacitor Cs1. Therefore, as shown in FIG. 2, the first electrode 121 and the displaceable electrode 100 function as a variable capacitor. It should be noted that the first capacitor Cs1 has an electrostatic capacitance between the first electrode 121 and the displaceable electrode 100. The electrostatic capacitance in the present disclosure may be simply referred to as a capacitance.

Returning to FIG. 1, for example, when the displaceable electrode 100 is displaced toward the first electrode 121, the distance between the first electrode 121 and the displaceable electrode 100 decreases, resulting in an increase in the capacitance of the first capacitor Cs1. Furthermore, the first electrode 121 outputs a signal corresponding to the change in the capacitance of the first capacitor Cs1.

The second electrode 122 is positioned to face, in the direction in which the displaceable electrode 100 is displaced, the portion of the displaceable electrode 100 that is connected to the second elastic part 102. Therefore, the second electrode 122 faces the side of the displaceable electrode 100 opposite to the first electrode 121. In addition, when the displaceable electrode 100 is displaced, the distance between the second electrode 122 and the displaceable electrode 100 changes, resulting in a change in the second capacitor Cs2. Therefore, as shown in FIG. 2, the second electrode 122 and the displaceable electrode 100 function as a variable capacitor. It should be noted that the second capacitor Cs2 is the capacitance between the second electrode 122 and the displaceable electrode 100.

Returning to FIG. 1, for example, when the displaceable electrode 100 is displaced toward the first electrode 121, the distance between the second electrode 122 and the displaceable electrode 100 increases, thereby decreasing the second capacitor Cs2. Accordingly, when the displaceable electrode 100 is displaced, the change in the second capacitor Cs2 is opposite to the change in the capacitance of first capacitor Cs1. Furthermore, the second electrode 122 outputs a signal corresponding to the change in the capacitance of the second capacitor Cs2.

Here, the capacitance of the first capacitor Cs1 when the displaceable electrode 100 is not displaced is assumed to be the same as the capacitance of the second capacitor Cs2 when the displaceable electrode 100 is not displaced, and this value is referred to as Cs0. It should be noted that “the same” includes manufacturing tolerances.

As described above, the sensor element 10 is configured as such. Next, the configuration of the capacitive sensor detection circuit used in the sensor element 10 will be described.

As shown in FIG. 2, the capacitive sensor detection circuit 20 is implemented as an Application Specific Integrated Circuit (ASIC), and includes a signal generator 22, a fully differential amplifier 24, a first feedback capacitor 31, a first feedback resistor 41, a second feedback capacitor 32, and a second feedback resistor 42. Furthermore, the capacitive sensor detection circuit 20 includes a calculator 50, a first parasitic capacitor 51, a second parasitic capacitor 52, a first capacitor 61, a second capacitor 62, and a controller 70. The signal generator may also be referred to as a signal generation circuit or a signal generation unit in the present disclosure. The calculator may also be referred to as a calculation circuit or a calculation unit in the present disclosure.

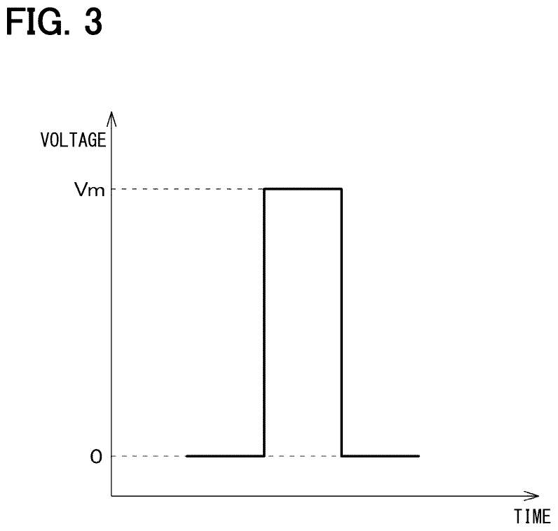

The signal generator 22 modulates the signal by including a modulator. In addition, the signal generator 22 outputs the modulated signal to the displaceable electrode 100. The signal output by the signal generator 22 is a signal having an input amplitude Vm, a frequency, and a phase, and, for example, as shown in FIG. 3, is set as a rectangular wave. It should be noted that the signal output by the signal generator 22 is not limited to a rectangular wave, and may also be a triangular wave, a sawtooth wave, a sine wave, or the like.

Here, the signal output from the signal generator 22 to the displaceable electrode 100 is referred to as the modulated signal S. A signal having an amplitude of input amplitude Vm, a frequency identical to that of the modulated signal S, and a phase opposite to the phase of the modulated signal S is referred to as the inverted-phase signal Sinv.

Then, with reference to FIG. 2, the signal generator 22 outputs the modulated signal S and the inverted-phase signal Sinv to a controller 70, which will be described later.

The fully differential amplifier 24 has a first input terminal 241, a second input terminal 242, a first output terminal 251, and a second output terminal 252.

The first input terminal 241 is configured as a non-inverting input terminal and is connected to the first electrode 121. Furthermore, a signal from the first electrode 121 is provided to the first input terminal 241.

The second input terminal 242 is an inverting input terminal and is connected to the second electrode 122. In addition, a signal from the second electrode 122 is provided to the second input terminal 242.

Here, the signal provided to the first input terminal 241 is referred to as the first input signal Vin1. The signal provided to the second input terminal 242 is referred to as the second input signal Vin2.

The first output terminal 251 outputs a signal corresponding to the first input signal Vin1 and the second input signal Vin2.

The second output terminal 252 outputs a signal corresponding to the first input signal Vin1 and the second input signal Vin2.

Furthermore, the signal output from the first output terminal 251 is referred to as the first output signal Vout1. The signal output from the second output terminal 252 is referred to as the second output signal Vout2.

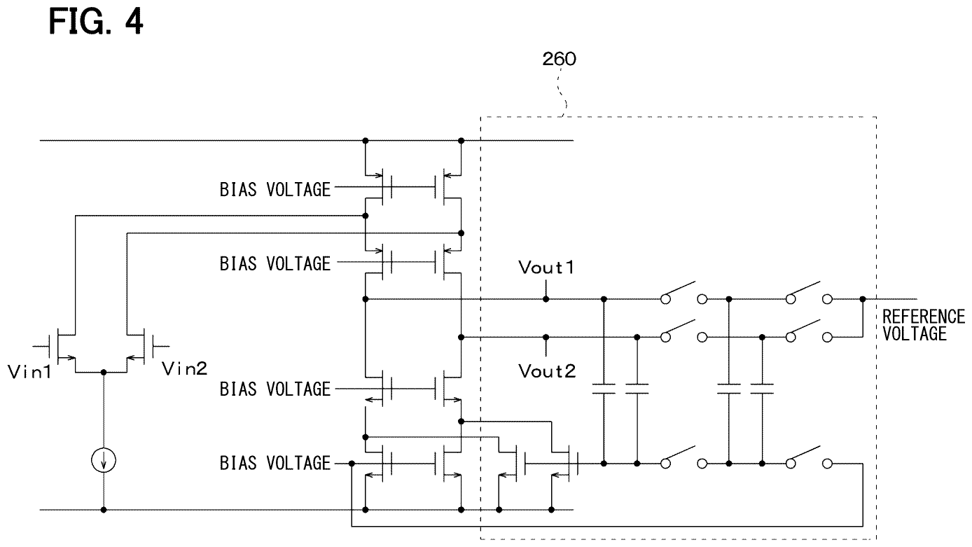

Then, the fully differential amplifier 24 includes an output common-mode feedback circuit 260 as shown in FIG. 4. Therefore, the voltage equal to half the sum of the first output signal Vout1 and the second output signal Vout2, that is, the voltage (Vout1+Vout2)/2, is controlled to be a predetermined voltage. The predetermined voltage is set based on experiments, simulations, or the like.

With reference to FIG. 2, one end of the first feedback capacitor 31 is connected to the first input terminal 241. The other end of the first feedback capacitor 31 is connected to the first output terminal 251.

One end of the second feedback capacitor 32 is connected to the second input terminal 242. The other end of the second feedback capacitor 32 is connected to the second output terminal 252.

One end of the first feedback resistor 41 is connected to the first input terminal 241 and to one end of the first feedback capacitor 31. The other end of the first feedback resistor 41 is connected to the first output terminal 251 and to the other end of the first feedback capacitor 31.

One end of the second feedback resistor 42 is connected to the second input terminal 242 and to one end of the second feedback capacitor 32. The other end of the second feedback resistor 42 is connected to the second output terminal 252 and to the other end of the second feedback capacitor 32.

Here, the capacitance of the first feedback capacitor 31 is referred to as the first feedback capacitor Cf1. The capacitance of the second feedback capacitor 32 is referred to as the second feedback capacitor Cf2. The electrical resistance of the first feedback resistor 41 is referred to as a resistance of the first resistor Rf1. The electrical resistance of the second feedback resistor 42 is referred to as a resistance of the second resistor Rf2.

A capacitance of the first feedback capacitor Cf1 is regarded as being equal to a capacitance of the second feedback capacitor Cf2, and both are denoted as Cf. Accordingly, it is defined that Cf1=Cf2=Cf. In addition, the resistance of the first resistor Rf1 is regarded as being equal to the resistance of the second resistance Rf2, and both are denoted as Rf. Therefore, it is defined that Rf1=Rf2=Rf.

The calculator 50 acquires the first output signal Vout1 and the second output signal Vout2. Furthermore, the calculator 50 calculates the displacement of the displaceable electrode 100 based on the acquired first output signal Vout1 and second output signal Vout2. In addition, the calculator 50 calculates the acceleration, pressure, and other parameters of the displaceable electrode 100 based on the calculated displacement of the displaceable electrode 100. As a result, the calculator 50 calculates the acceleration, pressure, and other parameters of a detection target (not shown) that displaces together with the displaceable electrode 100. It should be noted that the acceleration, pressure, and other parameters of the displaceable electrode 100 correspond to values relating to the displacement of the displaceable electrode 100.

One end of the first parasitic capacitor 51 is connected between the first electrode 121 and the first input terminal 241. The other end of the first parasitic capacitor 51 is connected to ground.

One end of the second parasitic capacitor 52 is connected between the second electrode 122 and the second input terminal 242. The other end of the second parasitic capacitor 52 is connected to ground.

One end of the first capacitor 61 is connected between the first electrode 121 and the first input terminal 241. The other end of the first capacitor 61 is connected to a controller 70, which will be described later.

One end of the second capacitor 62 is connected between the second electrode 122 and the second input terminal 242. The other end of the second capacitor 62 is connected to the controller 70, which will be described later.

Here, the capacitance of the first capacitor 61 is referred to as the first capacitance Ct1. The capacitance of the second capacitor 62 is referred to as the second capacitance Ct2.

The first capacitance Ct1 is set to be the same as the second capacitance Ct2, and is denoted as Ct0. Accordingly, Ct1=Ct2=Ct0.

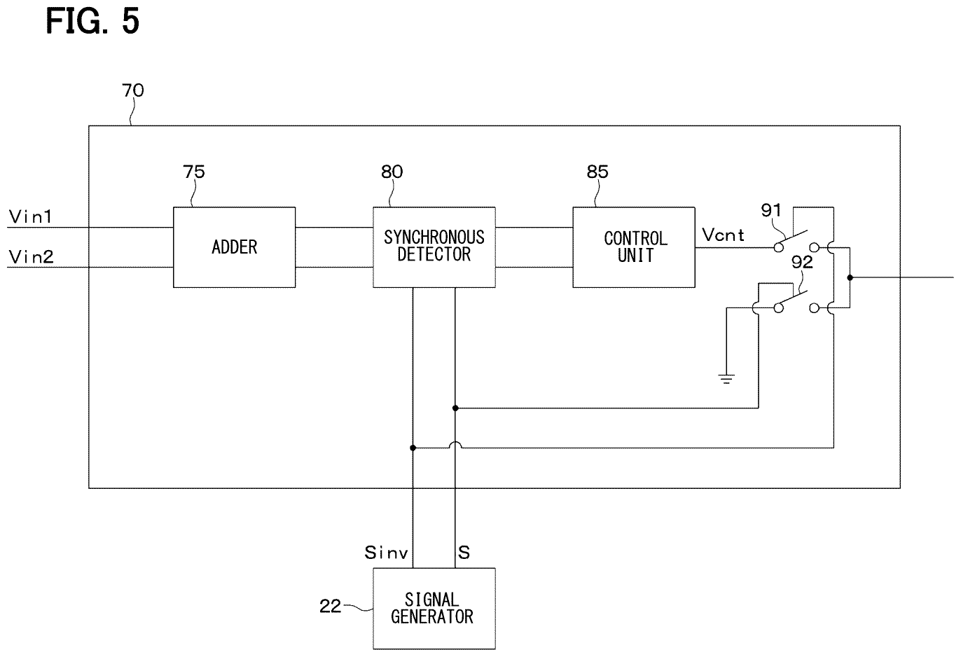

As shown in FIG. 5, the controller 70 includes an adder 75, a synchronous detector 80, a control unit 85, a first adjustment switch 91, and a second adjustment switch 92. The control unit corresponds to a control circuit in the present disclosure. The adder corresponds to an adder circuit, a summer, or a summing circuit in the present disclosure.

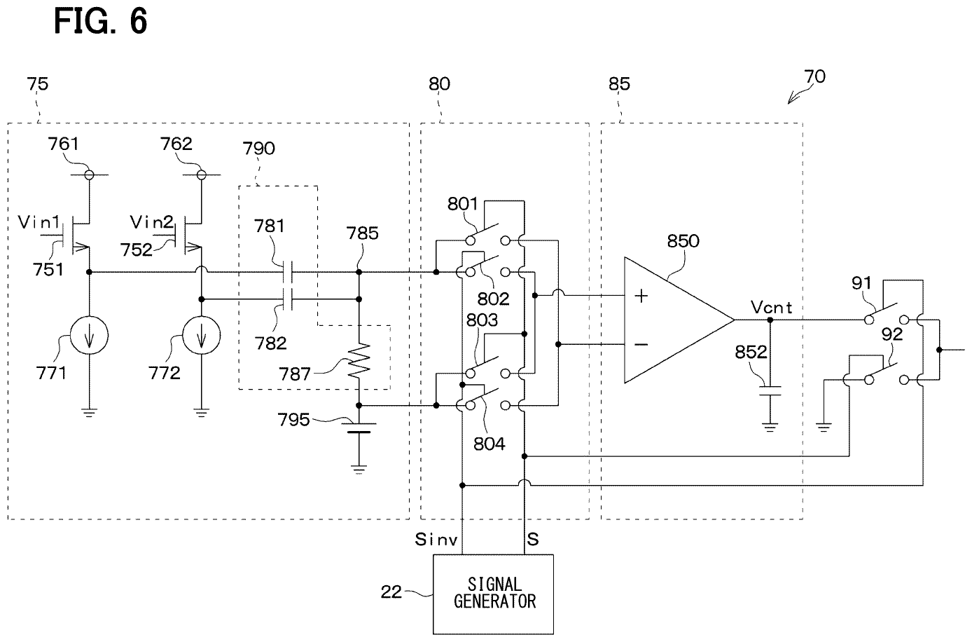

As shown in FIG. 6, the adder 75 includes, for example, a first voltage follower circuit 751, a first power supply 761, a first constant current source 771, a second voltage follower circuit 752, a second power supply 762, and a second constant current source 772. Furthermore, the adder 75 includes a first filter capacitor 781, a second filter capacitor 782, a junction 785, a filter resistor 787, a high-pass filter 790, and a reference power supply 795. The junction may also be referred to as a junction node in the present disclosure.

The first voltage follower circuit 751 acquires a first input signal Vin1 and outputs a signal corresponding to the acquired first input signal Vin1. Specifically, the first voltage follower circuit 751 includes at least one transistor. Here, the number of transistors in the first voltage follower circuit 751 is one. The transistor of the first voltage follower circuit 751 is, for example, a Metal-Oxide-Semiconductor Field-Effect Transistor (MOSFET). The drain electrode of the MOSFET in the first voltage follower circuit 751 is connected to the first power supply 761. The gate electrode of the MOSFET in the first voltage follower circuit 751 corresponds to the input terminal of the first voltage follower circuit 751, and is connected between the first electrode 121 and the first input terminal 241. The source electrode of the MOSFET in the first voltage follower circuit 751 corresponds to the output terminal of the first voltage follower circuit 751, and is connected to ground via the first constant current source 771. Accordingly, the first voltage follower circuit 751 acquires the first input signal Vin1 and outputs a signal with a voltage obtained by subtracting the first gate-source voltage Vgs1 from the voltage of the first input signal Vin1, that is, a signal with a voltage of Vin1-Vgs1. The first gate-source voltage Vgs1 is the voltage between the gate electrode and the source electrode of the MOSFET in the first voltage follower circuit 751.

The second voltage follower circuit 752 acquires the second input signal Vin2 and outputs a signal corresponding to the acquired second input signal Vin2. Specifically, the second voltage follower circuit 752 includes at least one transistor. Here, the number of transistors in the second voltage follower circuit 752 is one. Furthermore, the transistor in the second voltage follower circuit 752 is, for example, a MOSFET. The drain electrode of the MOSFET in the second voltage follower circuit 752 is connected to the second power supply 762. The gate electrode of the MOSFET in the second voltage follower circuit 752 corresponds to the input terminal of the second voltage follower circuit 752, and is connected between the second electrode 122 and the second input terminal 242. The source electrode of the MOSFET in the second voltage follower circuit 752 corresponds to the output terminal of the second voltage follower circuit 752, and is connected to ground via the second constant current source 772. Therefore, the second voltage follower circuit 752 acquires the second input signal Vin2 and outputs a signal with a voltage equal to the voltage of the second input signal Vin2 minus the second gate-source voltage Vgs2, that is, a voltage signal of Vin2-Vgs2. It should be noted that the second gate-source voltage Vgs2 is the voltage between the gate electrode and the source electrode of the MOSFET in the second voltage follower circuit 752.

One end of the first filter capacitor 781 is connected to the source electrode of the MOSFET in the first voltage follower circuit 751. Accordingly, the first filter capacitor 781 outputs the signal output from the first voltage follower circuit 751.

One end of the second filter capacitor 782 is connected to the source electrode of the MOSFET in the second voltage follower circuit 752. Accordingly, the second filter capacitor 782 outputs the signal output from the second voltage follower circuit 752.

The junction 785 is connected to the other end of the first filter capacitor 781 and the other end of the second filter capacitor 782. Accordingly, the signal at the junction 785 is the sum of the signal output from the first filter capacitor 781 and the signal output from the second filter capacitor 782. The signal output from the first filter capacitor 781 is a signal related to the first input signal Vin1, and the signal output from the second filter capacitor 782 is a signal related to the second input signal Vin2. Therefore, in the adder 75, a signal corresponding to the sum of the first input signal Vin1 and the second input signal Vin2 is obtained.

One end of the filter resistor 787 is connected, via the junction 785, to the other end of the first filter capacitor 781 and the other end of the second filter capacitor 782.

The high-pass filter 790 is composed of the first filter capacitor 781, the second filter capacitor 782, and the filter resistor 787. In addition, the high-pass filter 790 removes low-frequency components contained in the signal at the junction 785. As a result, the high-pass filter 790 removes the DC component contained in the signal at the junction 785. Therefore, the high-pass filter 790 removes the DC component contained in the signal relating to the sum of the first input signal Vin1 and the second input signal Vin2.

The positive terminal of the reference power supply 795 is connected to the junction 785 via the filter resistor 787. The negative terminal of the reference power supply 795 is connected to ground. The voltage of the reference power supply 795 is, for example, set to half the output voltage of the first power supply 761 or the second power supply 762.

The synchronous detector 80 demodulates the signal relating to the sum of the first input signal Vin1 and the second input signal Vin2 in accordance with the frequency and phase of the modulated signal S. For example, the synchronous detector 80 includes a first switch 801, a second switch 802, a third switch 803, and a fourth switch 804.

One end of the first switch 801 is connected to the junction 785. Furthermore, the first switch 801 is turned on and off in accordance with the modulated signal S. One end of the second switch 802 is connected to the junction 785. In addition, the second switch 802 is turned on and off in accordance with the inverted-phase signal Sinv. One end of the third switch 803 is connected to the other end of the filter resistor 787 and the positive terminal of the reference power supply 795. Furthermore, the third switch 803 is turned on and off in accordance with the modulated signal S. One end of the fourth switch 804 is connected to the other end of the filter resistor 787 and the positive terminal of the reference power supply 795. In addition, the fourth switch 804 is turned on and off in accordance with the inverted-phase signal Sinv.

Accordingly, the first switch 801, second switch 802, third switch 803, and fourth switch 804 are turned on and off by the modulated signal S and the inverted-phase signal Sinv. As a result, demodulation corresponding to the frequency and phase of the modulated signal S is performed on the signal at the junction 785. Therefore, demodulation corresponding to the frequency and phase of the modulated signal S is performed on the signal related to the sum of the first input signal Vin1 and the second input signal Vin2.

The control unit 85 includes a transconductance amplifier 850 for the control unit and a capacitor 852 for the control unit.

The non-inverting input terminal of the transconductance amplifier 850 for the control unit is connected to the other end of the second switch 802 and the other end of the third switch 803. Furthermore, the non-inverting input terminal of the transconductance amplifier 850 for the control unit is connected to the positive terminal of the reference power supply 795 via the third switch 803. The inverting input terminal of the transconductance amplifier 850 for the control unit is connected to the other end of the first switch 801 and the other end of the fourth switch 804. Additionally, the inverting input terminal of the transconductance amplifier 850 for the control unit is connected to the positive terminal of the reference power supply 795 via the fourth switch 804. Accordingly, the transconductance amplifier 850 for the control unit compares a signal related to the sum of the first input signal Vin1 and the second input signal Vin2, which have been demodulated by the synchronous detector 80, with a signal from the reference power supply 795.

One end of the capacitor 852 for the control unit is connected to the output terminal of the transconductance amplifier 850 for the control unit. The other end of the capacitor 852 for the control unit is connected to ground. Therefore, the control unit 85 includes a gm-C integrator by having the transconductance amplifier 850 for the control unit and the capacitor 852 for the control unit.

Furthermore, the control unit 85 uses a signal related to the sum of the first input signal Vin1 and the second input signal Vin2, both of which have been demodulated by the synchronous detector 80, a signal from the reference power supply 795, the transconductance amplifier 850 for the control unit, and the capacitor 852 for the control unit. As a result, the control unit 85 calculates a feedback amplitude Vont that brings the amplitude of the signal related to the sum of the first input signal Vin1 and the second input signal Vin2, both of which have been demodulated by the synchronous detector 80, to zero. In addition, the control unit 85 outputs a signal having the calculated feedback amplitude Vont to the first adjustment switch 91.

One end of the first adjustment switch 91 is connected to the output terminal of the transconductance amplifier 850 for the control unit and to one end of the capacitor 852 for the control unit. As a result, a signal having the feedback amplitude Vont is provided to the first adjustment switch 91. Furthermore, the other end of the first adjustment switch 91 is connected to the other end of the first capacitor 61 and the other end of the second capacitor 62. In addition, the first adjustment switch 91 is turned on and off in response to the inverted phase signal Sinv.

One end of the second adjustment switch 92 is connected to ground. Furthermore, the other end of the second adjustment switch 92 is connected to the other end of the first capacitor 61, the other end of the second capacitor 62, and the other end of the first adjustment switch 91. In addition, the second adjustment switch 92 is turned on and off in response to the modulated signal S.

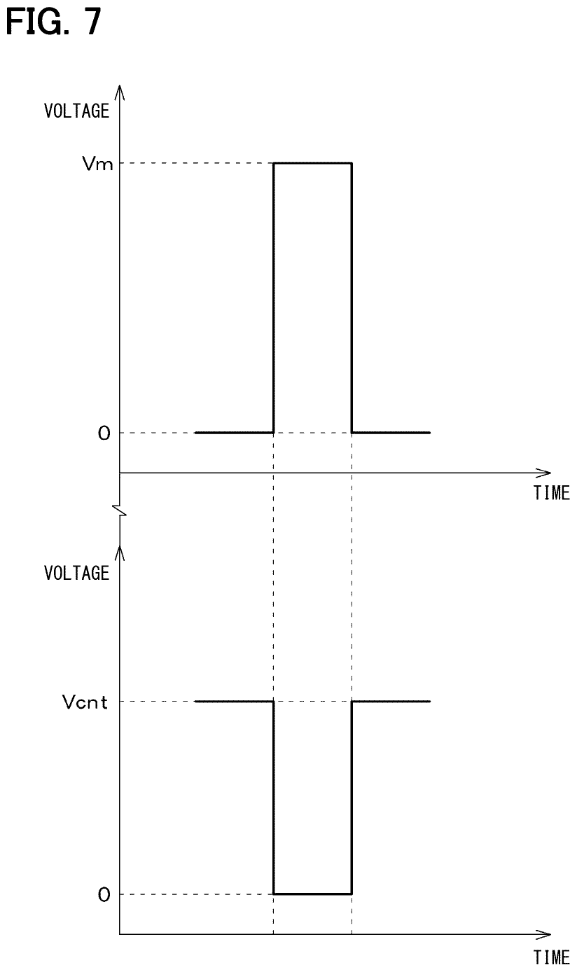

Furthermore, the first adjustment switch 91 and the second adjustment switch 92 are turned on and off by the modulated signal S and the inverted phase signal Sinv. As a result, as shown in FIG. 7, the frequency of the signal having the feedback amplitude Vont provided to the first adjustment switch 91 is adjusted such that it becomes the frequency of the modulated signal S. In addition, the phase of the signal having the feedback amplitude Vont provided to the first adjustment switch 91 is adjusted so that it is in the opposite phase to the phase of the modulated signal S, that is, so that it matches the phase of the inverted phase signal Sinv. The signal having the feedback amplitude Vont, whose frequency and phase have been adjusted, is output to the first capacitor 61 and the second capacitor 62, as shown in FIG. 2.

As described above, the capacitive sensor detection circuit 20 of the first embodiment is configured as described. Next, the operation of the capacitive sensor detection circuit 20 will be described.

The signal generator 22 outputs a modulated signal S, having an input amplitude Vm, frequency, and phase, to the displaceable electrode 100 and the controller 70. Furthermore, the signal generator 22 outputs an inverted-phase signal Sinv to the controller 70. In addition, the displaceable electrode 100 is displaced toward the first electrode 121. At this time, the capacitance of the first capacitor Cs1 increases. Furthermore, the capacitance of the second capacitor Cs2 decreases. The amount of change in the capacitance of the first capacitor Cs1 and the second capacitor Cs2 is denoted as ACs. At this time, the capacitance of the first capacitor Cs1 can be expressed by the following equation (1-1). Similarly, the capacitance of the second capacitor Cs2 can be expressed by the following equation (1-2). It should be noted that Cs0, as described above, is the capacitance value of the first capacitor Cs1 and the second capacitor Cs2 when the displaceable electrode 100 is not displaced.

$$Cs 1 = Cs 0 + Δ Cs \qquad ( 1 - 1 )$$

$$Cs 2 = Cs 0 - Δ Cs \qquad ( 1 - 2 )$$

Furthermore, the first electrode 121 outputs a signal corresponding to ACs to the first input terminal 241. As a result, the signal from the first electrode 121 is provided to the first input terminal 241. In addition, the second electrode 122 outputs a signal corresponding to ACs to the second input terminal 242. As a result, the signal from the second electrode 122 is provided to the second input terminal 242. At this time, the first output terminal 251 outputs a first output signal Vout1, corresponding to the first input signal Vin1 and the second input signal Vin2, to the calculator 50. The second output terminal 252 outputs a second output signal Vout2, corresponding to the first input signal Vin1 and the second input signal Vin2, to the calculator 50.

At this time, the amplitude of the difference between the first output signal Vout1 and the second output signal Vout2 can be expressed by the following equation (1-3), using the input amplitude Vm, ACs, and Cf. It should be noted that Cf, as described above, is the capacitance of the first feedback capacitor 31 and the second feedback capacitor 32. It should be noted that Vout1 in the following equation (1-3) denotes the amplitude of the first output signal Vout1. Vout2 in the following equation (1-3) denotes the amplitude of the second output signal Vout2.

$$Vout 1 - Vout 2 = 2 \times Vm \times Δ Cs / Cf \qquad ( 1 - 3 )$$

Accordingly, the calculator 50 acquires the first output signal Vout1 from the first output terminal 251. Furthermore, the calculator 50 acquires the second output signal Vout2 from the second output terminal 252. In addition, the calculator 50 calculates ACs using the acquired first output signal Vout1 and second output signal Vout2, the preset input amplitude Vm and Cf, and the above equation (1-3). Furthermore, the calculator 50 calculates the displacement of the displaceable electrode 100 from the calculated ACs. Additionally, the calculator 50 calculates the acceleration, pressure, or the like of the displaceable electrode 100 from the calculated displacement of the displaceable electrode 100. As a result, the calculator 50 calculates the acceleration, pressure, or the like of a detection object (not shown) that displaces together with the displaceable electrode 100.

Here, let the absolute value of the difference between Cs0 and the first capacitance Ct1 or the second capacitance Ct2 be ΔCe. Also, assume that the amplitude of the signals output from the controller 70 to the first capacitor 61 and the second capacitor 62 is the same as the input amplitude Vm.

At this time, the amplitude of the first input signal Vin1, whose frequency and phase correspond to the frequency and phase of the modulated signal S, is expressed by the following equation (1-4) using the input amplitude Vm, ΔCe, and Cf. The amplitude of the second input signal Vin2, whose frequency and phase correspond to those of the modulated signal S, is expressed by the following equation (1-5) using the input amplitude Vm, ΔCe, and Cf. It should be noted that Vin1 in the equation (1-4) below refers to the amplitude of the first input signal Vin1. Vin2 in the equation (1-5) below refers to the amplitude of the second input signal Vin2.

$$Vin 1 = Vm \times Δ Ce \times Cf \qquad ( 1 - 4 )$$

$$Vin 2 = Vm \times Δ Ce \times Cf \qquad ( 1 - 5 )$$

Furthermore, here it is assumed that the first input signal Vin1, represented by the above equation (1-4), is provided to the first input terminal 241. It is assumed that the second input signal Vin2, represented by the above equation (1-5), is provided to the second input terminal 242. At this time, since the fully differential amplifier 24 includes the output common-mode feedback circuit 260, the first input signal Vin1 and the second input signal Vin2 become common-mode (in phase). Therefore, the influence of the first input signal Vin1, represented by the above equation (1-4), and the second input signal Vin2, represented by the above equation (1-5), on the difference between the first output signal Vout1 and the second output signal Vout2, that is, on Vout1-Vout2, is small.

However, here, as described above, the capacitive sensor detection circuit 20 includes a first parasitic capacitor 51 and a second parasitic capacitor 52. In addition, the capacitance of the first parasitic capacitor 51 is denoted as the first parasitic capacitance Cp1. The capacitance of the second parasitic capacitor 52 is denoted as the second parasitic capacitance Cp2. The absolute value of the difference between the first parasitic capacitance Cp1 and the second parasitic capacitance Cp2 is denoted as ΔCp.

Then, the amplitude of the in-phase signal of the first input signal Vin1 and the second input signal Vin2 is a value related to Vm×ΔCe/Cf. Furthermore, based on this and ΔCp, the amplitude of the difference between the first output signal Vout1 and the second output signal Vout2 can be expressed using the input amplitude Vm, ΔCe, Cf, and ΔCp, as shown in the following equation (1-6). It should be noted that Vout1 in the following equation (1-6) refers to the amplitude of the first output signal Vout1. Vout2 in the following equation (1-6) refers to the amplitude of the second output signal Vout2.

$$Vout 1 - Vout 2 = V m \times Δ C e / C f \times Δ C p / C f \qquad ( 1 - 6 )$$

Therefore, the amplitude of the difference between the first output signal Vout1 and the second output signal Vout2 includes the value expressed by the right side of the above equation (1-6). Accordingly, the amplitude of the difference between the first output signal Vout1 and the second output signal Vout2, as represented by the above equation (1-6), becomes an offset component of the detected value such as acceleration or pressure, which is calculated from the above equation (1-3).

Furthermore, here, the amplitude of the first input signal Vin1, whose frequency and phase correspond to the frequency and phase of the modulated signal S, is expressed by the following equation (1-7) using the input amplitude Vm, the feedback amplitude Vont, Cs0, Ct0, and Cf. The amplitude of the second input signal Vin2, whose frequency and phase correspond to the frequency and phase of the modulated signal S, is expressed by the following equation (1-8) using the input amplitude Vm, the feedback amplitude Vont, Cs0, Ct0, and Cf. It should be noted that Ct0, as described above, is the capacitance of the first capacitor 61 and the second capacitor 62. It should be noted that Vin1 in the following equation (1-7) is the amplitude of the first input signal Vin1. Vin2 in the following equation (1-8) is the amplitude of the second input signal Vin2.

$$Vin 1 = ( Vm \times Cs 0 - Vcnt \times Ct 0 ) / Cf \qquad ( 1 - 7 )$$

$$Vin 2 = ( Vm \times Cs 0 - Vcnt \times Ct 0 ) / Cf \qquad ( 1 - 8 )$$

Accordingly, when Vm×Cs0-Vont×Ct0 is zero, the amplitudes of the first input signal Vin1 and the second input signal Vin2, whose frequencies and phases correspond to the frequency and phase of the modulated signal S, become zero. Therefore, even if there is a difference between Cs0 and Ct0, the offset component becomes zero. Therefore, even if there is a ΔCe, which is the absolute value of the difference between Cs0 and the first capacitance Ct1 or the second capacitance Ct2, the offset component becomes zero.

Therefore, the controller 70 calculates a feedback amplitude Vont that makes Vm×Cs0−Vont×Ct0 equal to zero. For this purpose, the controller 70 includes, for example, an adder 75, a synchronous detector 80, a control unit 85, a first adjustment switch 91, and a second adjustment switch 92.

Here, as described above, the first input terminal 241 is connected to the first electrode 121 and the first capacitor 61. The second input terminal 242 is connected to the second electrode 122 and the second capacitor 62. Accordingly, the first input signal Vin1 and the second input signal Vin2 are signals related to the input amplitude Vm, the feedback amplitude Vont, Cs0, and Ct0.

Therefore, the adder 75 acquires the first input signal Vin1 and the second input signal Vin2. The adder 75 also includes a first voltage follower circuit 751, a second voltage follower circuit 752, and a junction 785. As a result, the adder 75 obtains a signal corresponding to the sum of the first input signal Vin1 and the second input signal Vin2 from the acquired first input signal Vin1 and second input signal Vin2.

Furthermore, the high-pass filter 790 of the adder 75 removes low-frequency components contained in the signal corresponding to the sum of the first input signal Vin1 and the second input signal Vin2, which is obtained by the adder 75. As a result, the high-pass filter 790 removes the DC component contained in the signal corresponding to the sum of the first input signal Vin1 and the second input signal Vin2, which is obtained by the adder 75.

The synchronous detector 80 performs demodulation, corresponding to the frequency and phase of the modulated signal S, on the signal corresponding to the sum of the first input signal Vin1 and the second input signal Vin2 from which the DC component has been removed by the high-pass filter 790.

The control unit 85 uses the signal corresponding to the sum of the first input signal Vin1 and the second input signal Vin2, which has been demodulated by the synchronous detector 80, and the signal from the reference power supply 795. As a result, the control unit 85 calculates a feedback amplitude Vont that makes the amplitude of the signal corresponding to the sum of the first input signal Vin1 and the second input signal Vin2, which has been demodulated by the synchronous detector 80, zero. As a result, a feedback amplitude Vont that makes Vm×Cs0−Vont×Ct0 zero is calculated. In addition, the control unit 85 outputs a signal having the calculated feedback amplitude Vont to the first adjustment switch 91.

Furthermore, the first adjustment switch 91 and the second adjustment switch 92 are turned on and off by the modulated signal S and the inverted-phase signal Sinv. As a result, the frequency of the signal with the feedback amplitude Vont provided to the first adjustment switch 91 becomes the frequency of the modulated signal S. In addition, the phase of the signal with the feedback amplitude Vont provided to the first adjustment switch 91 becomes the phase opposite to that of the modulated signal S, that is, the phase of the inverted-phase signal Sinv. Then, the signal whose amplitude is set to the feedback amplitude Vont, whose frequency is the same as that of the modulated signal S, and whose phase is opposite to the phase of the modulated signal S, is output to the first capacitor 61 and the second capacitor 62. As a result, the amplitudes of the first input signal Vin1 and the second input signal Vin2, whose frequencies and phases correspond to the frequency and phase of the modulated signal S, approach zero. Therefore, the offset component becomes zero.

As described above, the capacitive sensor detection circuit 20 operates in this manner. Next, in the capacitive sensor detection circuit 20, an explanation will be given regarding how the output signal corresponding to a change in capacitance becomes a signal that is continuous with respect to time.

A comparative detection circuit for a capacitive sensor that may detect acceleration from a change in capacitance caused by displacement of the electrodes. In the above-mentioned comparative detection circuit, the input voltage of the fully differential amplifier may be reset. However, while the input voltage of the fully differential amplifier is being reset, the signal output from the fully differential amplifier may not contain the signal corresponding to acceleration, and thus becomes a signal that is discontinuous with respect to time.

In contrast, the capacitive sensor detection circuit 20 of the present embodiment includes a controller 70. The controller 70 acquires a first input signal Vin1 and a second input signal Vin2, which are signals relating to the input amplitude Vm, Cs0, and Ct0. Furthermore, the controller 70 outputs a signal having a feedback amplitude Vont to the first capacitor 61 and the second capacitor 62. The feedback amplitude Vont brings the amplitudes of the first input signal Vin1 and the second input signal Vin2, whose frequency and phase correspond to the frequency and phase of the modulated signal S, close to zero. In addition, the frequency of the signal having the feedback amplitude Vont is set to be the same as or corresponds to the frequency of the modulated signal S. Furthermore, the phase of the signal having the feedback amplitude Vont is set to be opposite to the phase of the modulated signal S.

As a result, the amplitudes of the first input signal Vin1 and the second input signal Vin2, whose frequency and phase correspond to the frequency and phase of the modulated signal S, are continuously brought closer to zero. Accordingly, it is no longer necessary to provide a reset period for the first input signal Vin1 and the second input signal Vin2. Therefore, the output signal from the fully differential amplifier 24, which is an output signal corresponding to changes in the first capacitor Cs1 and the second capacitor Cs2, becomes a signal that is continuous with respect to time.

In addition, in the above-mentioned comparative detection circuit, noise may retained in each capacitor when a reset is performed. Therefore, in the above-mentioned comparative detection circuit, the accuracy of detecting a change in capacitance is reduced.

In contrast, in the capacitive sensor detection circuit 20 of the present embodiment, since the output signal corresponding to changes in the capacitance of the first capacitor Cs1 and the capacitance of the second capacitor Cs2 becomes a signal that is continuous with respect to time, noise retained in each capacitor is suppressed. Therefore, the reduction in the accuracy of detecting changes in capacitance is suppressed.

Furthermore, the capacitive sensor detection circuit 20 of the first embodiment also provides the effects described below.

The controller 70 includes the adder 75, the synchronous detector 80, and the control unit 85. As a result, the controller 70 can more easily calculate the feedback amplitude Vont.

The controller 70 includes the high-pass filter 790. The high-pass filter 790 removes the DC component contained in the signal related to the sum of the first input signal Vin1 and the second input signal Vin2.

The high-pass filter 790 makes it easier to adjust the gain of the control unit 85. Therefore, oscillation of the feedback amplitude Vont in the control unit 85 is suppressed.

The adder 75 includes the first voltage follower circuit 751, the first filter capacitor 781, the second voltage follower circuit 752, the second filter capacitor 782, and the junction 785.

The first voltage follower circuit 751 suppresses the flow of current, which should flow from the first electrode 121 to the first input terminal 241, into the controller 70. Furthermore, the second voltage follower circuit 752 suppresses the flow of current, which should flow from the second electrode 122 to the second input terminal 242, into the controller 70. Accordingly, it is suppressed that the controller 70 interferes with the operation of the fully differential amplifier 24.

The synchronous detector 80 includes the first switch 801, the second switch 802, the third switch 803, and the fourth switch 804. The control unit 85 includes the transconductance amplifier 850 for the control unit and the capacitor 852 for the control unit.

As a result, demodulation corresponding to the frequency and phase of the modulated signal S can be more easily performed on the signal related to the sum of the first input signal Vin1 and the second input signal Vin2. In addition, calculation of the feedback amplitude Vont is facilitated.

### Second Embodiment

In the second embodiment, the configurations of the synchronous detector 80 and the control unit 85 differ from those in the first embodiment. Other than this, the configuration is the same as in the first embodiment.

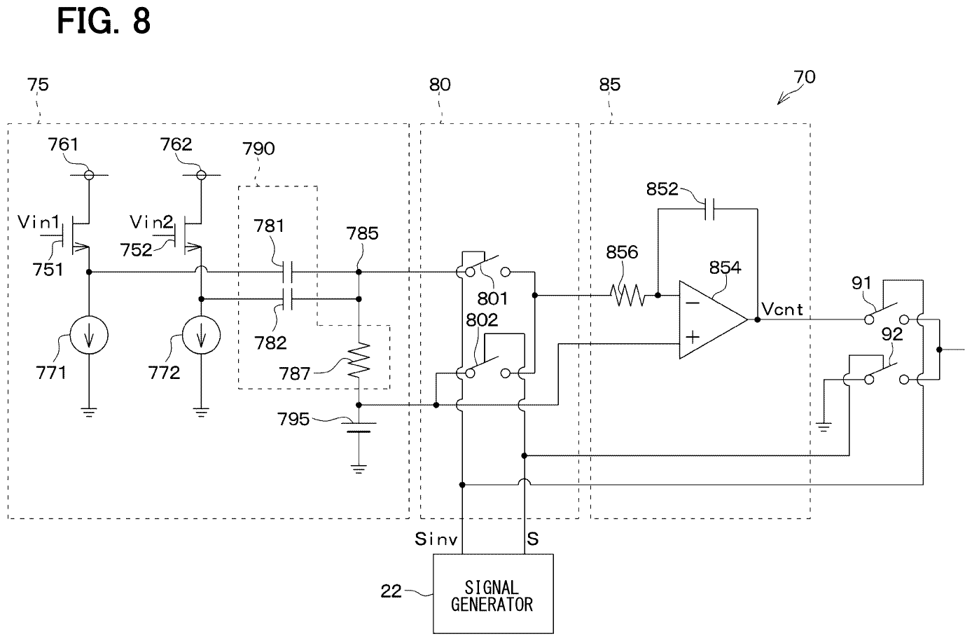

Specifically, as shown in FIG. 8, the synchronous detector 80 includes the first switch 801 and the second switch 802, but does not include the third switch 803 and the fourth switch 804.

In addition, one end of the first switch 801 is connected to the junction 785. Furthermore, the first switch 801 is turned on and off in accordance with the inverted-phase signal Sinv. In addition, one end of the second switch 802 is connected to the other end of the filter resistor 787 and to the positive terminal of the reference power supply 795. Furthermore, the second switch 802 is turned on and off in accordance with the modulated signal S.

Accordingly, the first switch 801 and the second switch 802 are turned on and off by the modulated signal S and the inverted-phase signal Sinv. As a result, demodulation corresponding to the frequency and phase of the modulated signal S is performed on the signal at the junction 785. Therefore, demodulation corresponding to the frequency and phase of the modulated signal S is performed on the signal related to the sum of the first input signal Vin1 and the second input signal Vin2.

The control unit 85 includes an operational amplifier 854 for the control unit instead of the transconductance amplifier 850 for the control unit. In addition, the control unit 85 includes a resistor 856 for the control unit in addition to the capacitor 852 for the control unit. The non-inverting input terminal of the operational amplifier 854 for the control unit is connected to one end of the second switch 802, the other end of the filter resistor 787, and the positive terminal of the reference power supply 795. The inverting input terminal of the operational amplifier 854 for the control unit is connected, via the resistor 856 for the control unit, to the other end of the first switch 801 and the other end of the second switch 802. Accordingly, the operational amplifier 854 for the control unit compares a signal related to the sum of the first input signal Vin1 and the second input signal Vin2, which have been demodulated by the synchronous detector 80, with a signal from the reference power supply 795.

Furthermore, one end of the capacitor 852 for the control unit is connected to the inverting input terminal of the operational amplifier 854 for the control unit. The other end of the capacitor 852 for the control unit is connected to the output terminal of the operational amplifier 854 for the control unit. Therefore, the control unit 85, by having the operational amplifier 854 for the control unit and the capacitor 852 for the control unit, functions as an integrator with capacitive feedback.

In addition, the control unit 85 utilizes a signal related to the sum of the first input signal Vin1 and the second input signal Vin2, which have been demodulated by the synchronous detector 80, a signal from the reference power supply 795, the operational amplifier 854 for the control unit, the capacitor 852 for the control unit, and the resistor 856 for the control unit. As a result, the control unit 85 calculates a feedback amplitude Vont that brings the amplitude of the signal related to the sum of the first input signal Vin1 and the second input signal Vin2, demodulated by the synchronous detector 80, to zero. Furthermore, the control unit 85 outputs a signal having the calculated feedback amplitude Vont to the first adjustment switch 91.

In addition, the first adjustment switch 91 and the second adjustment switch 92 are turned on and off by the modulated signal S and the inverted-phase signal Sinv. The frequency of the signal with the feedback amplitude Vont provided to the first adjustment switch 91 becomes the frequency of the modulated signal S. Furthermore, the phase of the signal with the feedback amplitude Vont provided to the first adjustment switch 91 is opposite to the phase of the modulated signal S, that is, it becomes the phase of the inverted-phase signal Sinv. Then, the signal whose amplitude is set to the feedback amplitude Vont, whose frequency is the same as that of the modulated signal S, and whose phase is opposite to that of the modulated signal S, is output to the first capacitor 61 and the second capacitor 62. As a result, the amplitudes of the first input signal Vin1 and the second input signal Vin2, whose frequency and phase correspond to those of the modulated signal S, approach zero. Therefore, the offset component becomes zero.

As described above, the capacitive sensor detection circuit 20 according to the second embodiment is configured as described. In this second embodiment as well, the same effects as those of the first embodiment are achieved.

### Third Embodiment

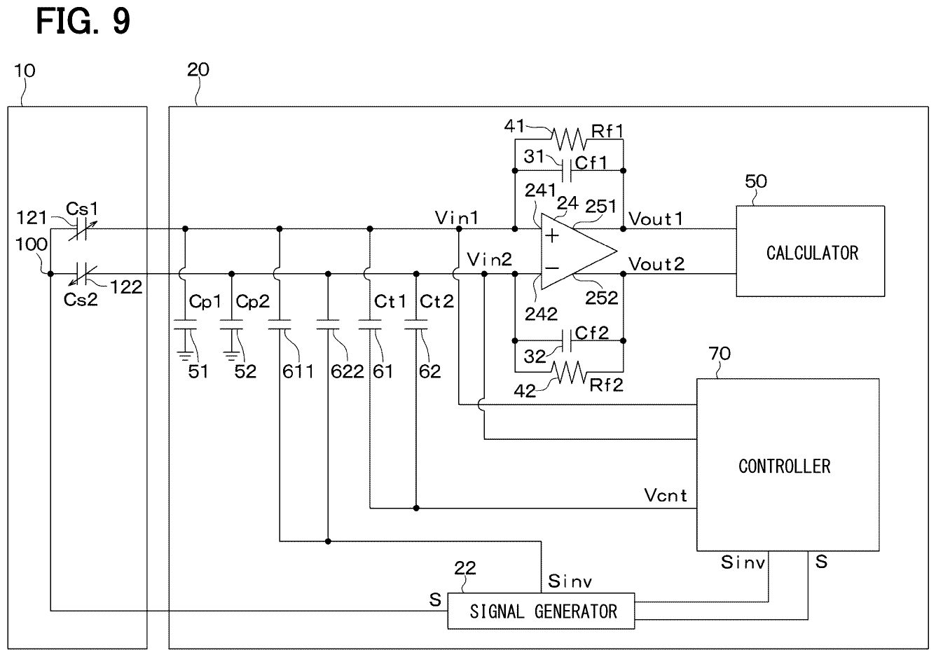

In the third embodiment, as shown in FIG. 9, the capacitive sensor detection circuit 20 further includes a first adjustment capacitor 611 and a second adjustment capacitor 622. Other than this, the configuration is the same as that of the first embodiment.

One end of the first adjustment capacitor 611 is connected between the first electrode 121 and the first input terminal 241. The other end of the first adjustment capacitor 611 is connected to the signal generator 22.

One end of the second adjustment capacitor 622 is connected between the second electrode 122 and the second input terminal 242. The other end of the second adjustment capacitor 622 is connected to the signal generator 22.

Further, the signal generator 22 outputs an inverted-phase signal Sinv to the first adjustment capacitor 611 and the second adjustment capacitor 622.

As described above, the capacitive sensor detection circuit 20 according to the third embodiment is configured as described. In this third embodiment as well, the same effects as those of the first embodiment are achieved. Furthermore, in the third embodiment, the following effects are also achieved.

The capacitive sensor detection circuit 20 further includes a first adjustment capacitor 611 and a second adjustment capacitor 622. In addition, the signal generator 22 outputs the inverted-phase signal Sinv to the first adjustment capacitor 611 and the second adjustment capacitor 622.

The first adjustment capacitor 611 adjusts the current between the first electrode 121 and the first input terminal 241. As a result, when a signal having a feedback amplitude Vent is output from the controller 70 to the first capacitor 61, the increase in current flowing from the controller 70 to the first capacitor 61 is suppressed. Similarly, the second adjustment capacitor 622 adjusts the current between the second electrode 122 and the second input terminal 242. Therefore, when a signal having a feedback amplitude Vont is output from the controller 70 to the first capacitor 61, the increase in current flowing from the controller 70 to the first capacitor 61 is suppressed. Accordingly, the current consumption of the controller 70 is suppressed.

### Fourth Embodiment

In the fourth embodiment, the configuration of the fully differential amplifier 24 and the processing of the controller 70 differ from those in the first embodiment. Other than this, the configuration is the same as in the first embodiment.

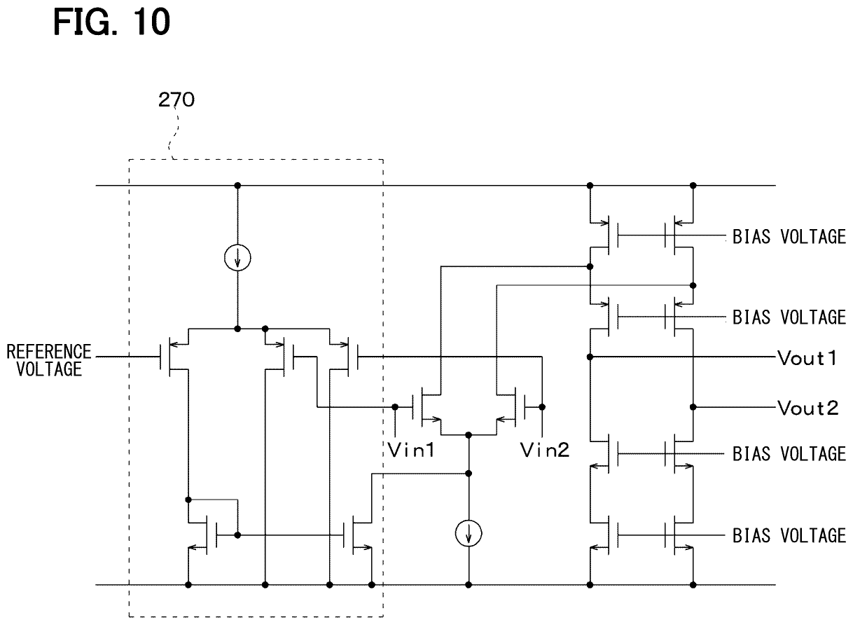

The fully differential amplifier 24 includes an input common-mode feedback circuit 270, as shown in FIG. 10, instead of the output common-mode feedback circuit 260. Therefore, the voltage equal to half the sum of the first input signal Vin1 and the second input signal Vin2, that is, (Vin1+Vin2)/2, is controlled to be a predetermined voltage. The predetermined voltage is set through experiments, simulations, or the like.

Since the fully differential amplifier 24 includes the input common-mode feedback circuit 270, in the fourth embodiment, unlike in the first embodiment, the first input signal Vin1, whose frequency and phase correspond to the frequency and phase of the modulated signal S, is not expressed as in the above equation (1-7). Similarly, the second input signal Vin2, whose frequency and phase correspond to the frequency and phase of the modulated signal S, is not expressed as in the above equation (1-8).

In contrast, the first output signal Vout1, whose frequency and phase correspond to the frequency and phase of the modulated signal S, is expressed using the input amplitude Vm, the feedback amplitude Vont, Cs0, Ct0, and Cf, as shown in the following equation (2-1). Furthermore, the second output signal Vout2, whose frequency and phase correspond to the frequency and phase of the modulated signal S, is expressed using the input amplitude Vm, the feedback amplitude Vont, Cs0, Ct0, and Cf, as shown in the following equation (2-2).

$$Vout 1 = ( Vm \times Cs 0 - Vcnt \times Ct 0 ) / Cf \qquad ( 2 - 1 )$$

$$Vout 2 = ( Vm \times Cs 0 - Vcnt \times Ct 0 ) / Cf \qquad ( 2 - 2 )$$

Accordingly, when Vm×Cs0−Vont×Ct0 is zero, both the first output signal Vout1 and the second output signal Vout2, whose frequency and phase correspond to those of the modulated signal S, become zero, resulting in the offset component being eliminated.

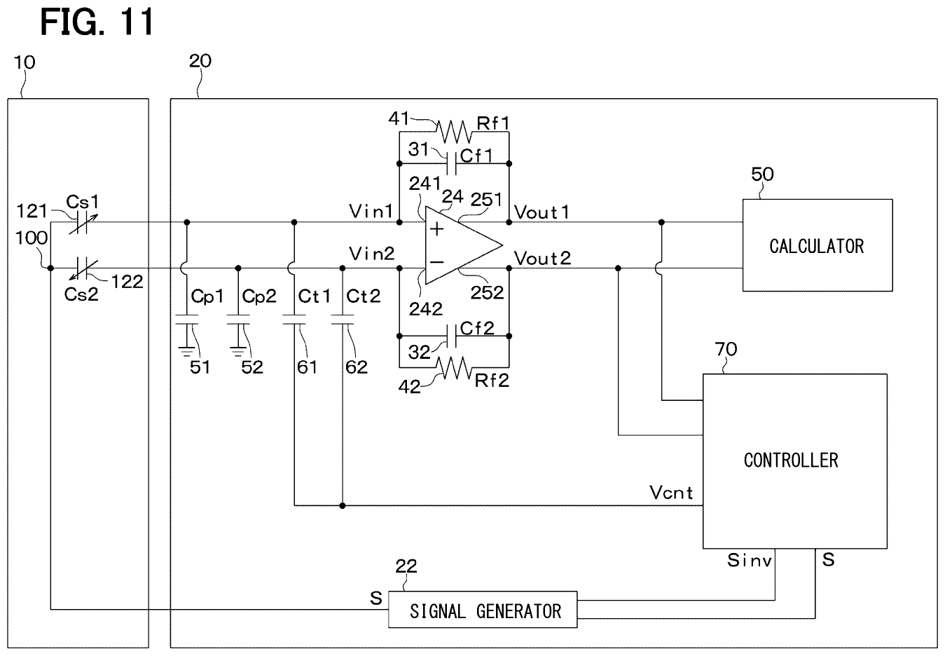

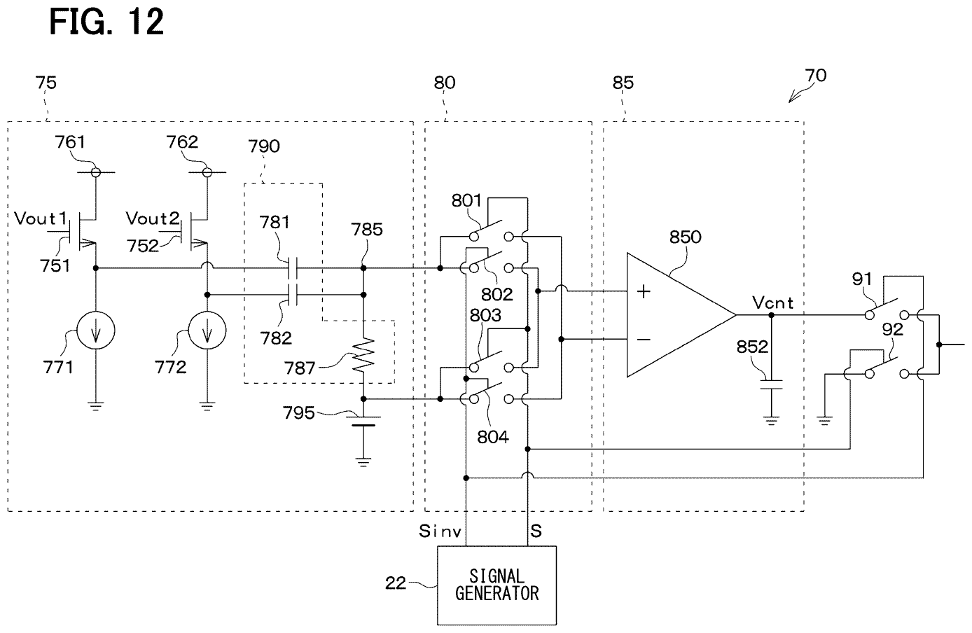

Therefore, the controller 70 calculates Vont such that Vm×Cs0−Vont×Ct0 becomes zero. To achieve this, the controller 70 includes, for example, as shown in FIGS. 11 and 12, the adder 75, the synchronous detector 80, the control unit 85, the first adjustment switch 91, and the second adjustment switch 92.

Here, as described above, the first input terminal 241 is connected to the first electrode 121 and the first capacitor 61. The second input terminal 242 is connected to the second electrode 122 and the second capacitor 62. Accordingly, the first input signal Vin1 and the second input signal Vin2 are signals related to the input amplitude Vm, the feedback amplitude Vont, Cs0, and Ct0. In addition, the first output terminal 251 outputs a signal corresponding to the first input signal Vin1 and the second input signal Vin2. The second output terminal 252 outputs a signal corresponding to the first input signal Vin1 and the second input signal Vin2. Therefore, the first output signal Vout1 and the second output signal Vout2 are signals related to the input amplitude Vm, the feedback amplitude Vont, Cs0, and Ct0.

Accordingly, the adder 75 acquires the first output signal Vout1 and the second output signal Vout2. Furthermore, the adder 75 includes a first voltage follower circuit 751, a second voltage follower circuit 752, and a junction 785. As a result, the adder 75 obtains a signal corresponding to the sum of the first output signal Vout1 and the second output signal Vout2 from the acquired first output signal Vout1 and second output signal Vout2.

In addition, the high-pass filter 790 of the adder 75 removes low-frequency components contained in the signal related to the sum of the first output signal Vout1 and the second output signal Vout2 obtained by the adder 75. As a result, the high-pass filter 790 removes the DC component contained in the signal related to the sum of the first output signal Vout1 and the second output signal Vout2 obtained by the adder 75.

The synchronous detector 80 performs demodulation, corresponding to the frequency and phase of the modulated signal S, on the signal related to the sum of the first output signal Vout1 and the second output signal Vout2 from which the DC component has been removed by the high-pass filter 790.

The control unit 85 uses both the signal related to the sum of the first output signal Vout1 and the second output signal Vout2 demodulated by the synchronous detector 80, and the signal from the reference power supply 795. As a result, the control unit 85 calculates a feedback amplitude Vont that brings the amplitude of the signal related to the sum of the first output signal Vout1 and the second output signal Vout2, which has been demodulated by the synchronous detector 80, to zero. As a result, a feedback amplitude Vont that brings Vm×Cs0−Vont×Ct0 to zero is calculated. In addition, the control unit 85 outputs a signal having the calculated feedback amplitude Vont to the first adjustment switch 91.

Furthermore, the first adjustment switch 91 and the second adjustment switch 92 are turned on and off by the modulated signal S and the inverted-phase signal Sinv. As a result, the frequency of the signal with the feedback amplitude Vont provided to the first adjustment switch 91 becomes the frequency of the modulated signal S. In addition, the phase of the signal with the feedback amplitude Vont provided to the first adjustment switch 91 becomes the phase opposite to that of the modulated signal S, that is, the phase of the inverted-phase signal Sinv. Then, the signal whose amplitude is set to the feedback amplitude Vont, whose frequency is the same as that of the modulated signal S, and whose phase is opposite to the phase of the modulated signal S is output to the first capacitor 61 and the second capacitor 62. As a result, the amplitudes of the first output signal Vout1 and the second output signal Vout2, whose frequencies and phases correspond to those of the modulated signal S, approach zero. Therefore, the offset component becomes zero.

As described above, the capacitive sensor detection circuit 20 of the fourth embodiment is configured as described, and the controller 70 performs processing. In this fourth embodiment as well, the same effects as those of the first embodiment are achieved.

### Fifth Embodiment

In the fifth embodiment, the configurations of the synchronous detector 80 and the control unit 85 differ from those in the fourth embodiment. Other than this, the configuration is the same as that of the fourth embodiment.

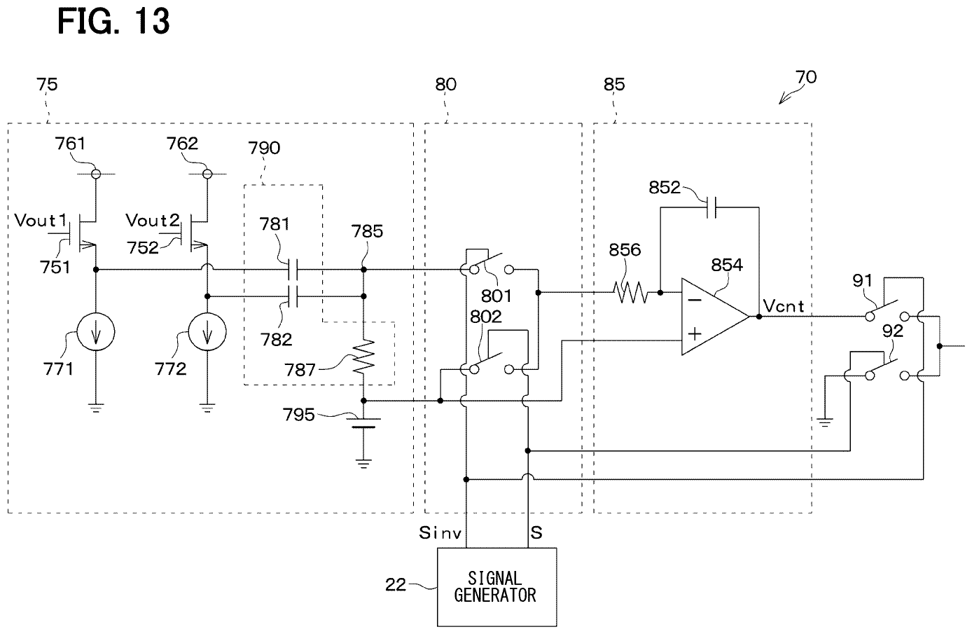

The fifth embodiment is a configuration in which the second embodiment and the fourth embodiment are combined. Specifically, as shown in FIG. 13, the synchronous detector 80 includes the first switch 801 and the second switch 802, but does not include the third switch 803 and the fourth switch 804.

In addition, one end of the first switch 801 is connected to the junction 785. Furthermore, the first switch 801 is turned on and off in accordance with the inverted-phase signal Sinv. In addition, one end of the second switch 802 is connected to the other end of the filter resistor 787 and the positive terminal of the reference power supply 795. Furthermore, the second switch 802 is turned on and off in accordance with the modulated signal S.

Accordingly, the first switch 801 and the second switch 802 are turned on and off by the modulated signal S and the inverted-phase signal Sinv. As a result, demodulation corresponding to the frequency and phase of the modulated signal S is performed on the signal at the junction 785. Therefore, demodulation corresponding to the frequency and phase of the modulated signal S is performed on the signal relating to the sum of the first output signal Vout1 and the second output signal Vout2.

The control unit 85 includes a operational amplifier 854 for the control unit instead of the transconductance amplifier 850 for the control unit. In addition, the control unit 85 includes a resistor 856 for the control unit in addition to the capacitor 852 for the control unit. The non-inverting input terminal of the operational amplifier 854 for the control unit is connected to one end of the second switch 802, the other end of the filter resistor 787, and the positive terminal of the reference power supply 795. The inverting input terminal of the operational amplifier 854 for the control unit is connected, via the resistor 856 for the control unit, to the other end of the first switch 801 and the other end of the second switch 802. Accordingly, the operational amplifier 854 for the control unit compares a signal related to the sum of the first output signal Vout1 and the second output signal Vout2, which have been demodulated by the synchronous detector 80, with a signal from the reference power supply 795.

Furthermore, one end of the capacitor 852 for the control unit is connected to the inverting input terminal of the operational amplifier 854 for the control unit. The other end of the capacitor 852 for the control unit is connected to the output terminal of the operational amplifier 854 for the control unit. Therefore, the control unit 85, including the operational amplifier 854 for the control unit and the capacitor 852 for the control unit, functions as an integrator with capacitor feedback.

In addition, the control unit 85 uses a signal related to the sum of the first output signal Vout1 and the second output signal Vout2, which have been demodulated by the synchronous detector 80, a signal from the reference power supply 795, the operational amplifier 854 for the control unit, the capacitor 852 for the control unit, and the resistor 856 for the control unit. As a result, the control unit 85 calculates a feedback amplitude Vont that brings the amplitude of the signal related to the sum of the first output signal Vout1 and the second output signal Vout2, which have been demodulated by the synchronous detector 80, to zero. Furthermore, the control unit 85 outputs a signal having the calculated feedback amplitude Vont to the first adjustment switch 91.

In addition, the first adjustment switch 91 and the second adjustment switch 92 are turned on and off by the modulated signal S and the inverted-phase signal Sinv. The frequency of the signal with the feedback amplitude Vont provided to the first adjustment switch 91 becomes the frequency of the modulated signal S. Furthermore, the phase of the signal with the feedback amplitude Vont provided to the first adjustment switch 91 is opposite to the phase of the modulated signal S, that is, it is in phase with the inverted-phase signal Sinv. Then, the signal whose amplitude is set to the feedback amplitude Vont, whose frequency is the same as that of the modulated signal S, and whose phase is opposite to that of the modulated signal S, is output to the first capacitor 61 and the second capacitor 62. As a result, the amplitudes of the first output signal Vout1 and the second output signal Vout2, whose frequency and phase correspond to the frequency and phase of the modulated signal S, approach zero. Therefore, the offset component becomes zero.

As described above, the capacitive sensor detection circuit 20 of the fifth embodiment is configured in this manner. In this fifth embodiment as well, the same effects as those of the fourth embodiment are achieved.

### Sixth Embodiment

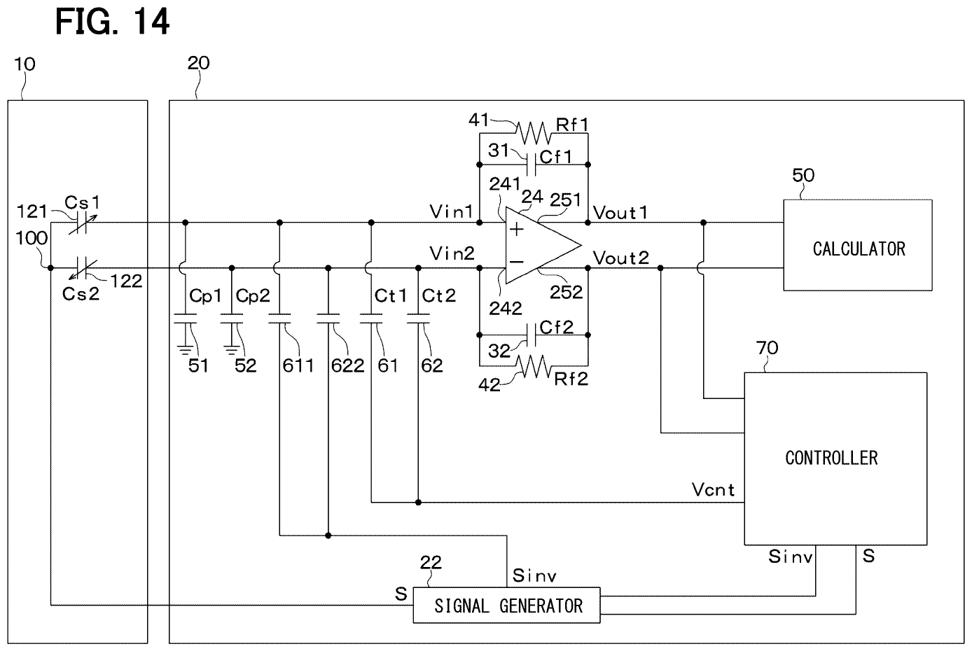

In the sixth embodiment, as shown in FIG. 14, the capacitive sensor detection circuit 20 further includes the first adjustment capacitor 611 and the second adjustment capacitor 622. The other aspects are the same as those of the fourth embodiment.

The sixth embodiment is a form in which the third embodiment and the fourth embodiment are combined. Specifically, one end of the first adjustment capacitor 611 is connected between the first electrode 121 and the first input terminal 241. The other end of the first adjustment capacitor 611 is connected to the signal generator 22.

One end of the second adjustment capacitor 622 is connected between the second electrode 122 and the second input terminal 242. The other end of the second adjustment capacitor 622 is connected to the signal generator 22. Further, the signal generator 22 outputs the inverted-phase signal Sinv to the first adjustment capacitor 611 and the second adjustment capacitor 622.

As described above, the capacitive sensor detection circuit 20 of the sixth embodiment is configured as follows. In this sixth embodiment as well, similar effects to those of the fourth embodiment are achieved. Furthermore, in the sixth embodiment, effects similar to those described in the third embodiment are also achieved.

### OTHER EMBODIMENTS

The present disclosure is not limited to the above embodiments, and various modifications may be made to the above embodiments as appropriate. It goes without saying that, in each of the above embodiments, the elements constituting the embodiments are not necessarily essential unless it is expressly stated that they are essential or it is considered self-evident in principle that they are essential.

The control unit (controller) and its methods described in the present disclosure may also be implemented by a dedicated computer provided by configuring a processor and memory programmed to execute one or more functions embodied as a computer program. Alternatively, the control unit and its methods described in the present disclosure may be implemented by a dedicated computer provided by configuring the processor with one or more dedicated hardware logic circuits. Alternatively, the control unit and its methods described in the present disclosure may be implemented by one or more dedicated computers configured by a combination of a processor and memory programmed to execute one or more functions, and a processor configured with one or more hardware logic circuits. Furthermore, the computer program may be stored as instructions executable by a computer on a non-transitory, tangible, computer-readable recording medium.

In each of the above embodiments, the number of transistors in the first voltage follower circuit 751 is one. In contrast, the number of transistors in the first voltage follower circuit 751 is not limited to one, and may be two or more. In addition, the number of transistors in the second voltage follower circuit 752 is one. In contrast, the number of transistors in the second voltage follower circuit 752 is not limited to one, and may be two or more.

In each of the above embodiments, the transistors of the first voltage follower circuit 751 and the second voltage follower circuit 752 are MOSFETs. In contrast, the transistors of the first voltage follower circuit 751 and the second voltage follower circuit 752 are not limited to MOSFETs, and may be, for example, bipolar transistors or the like.

In each of the above embodiments, the capacitance of the first capacitor Cs1 when the displaceable electrode 100 is not displaced is set to be the same as the capacitance of the second capacitor Cs2 when the displaceable electrode 100 is not displaced, and is denoted as Cs0. In contrast, the capacitance of the first capacitor Cs1 when the displaceable electrode 100 is not displaced is not limited to being the same as the capacitance of the second capacitor Cs2 when the displaceable electrode 100 is not displaced. The capacitance of the first capacitor Cs1 when the displaceable electrode 100 is not displaced may be different from the capacitance of the second capacitor Cs2 when the displaceable electrode 100 is not displaced.

In each of the above embodiments, the first feedback capacitor Cf1 is set to be the same as the second feedback capacitor Cf2, and is denoted as Cf. In contrast, the first feedback capacitor Cf1 is not limited to being the same as the second feedback capacitor Cf2. The first feedback capacitor Cf1 may be different from the second feedback capacitor Cf2.

In each of the above embodiments, the resistance of the first resistor Rf1 is set to be the same as the resistance of the second resistor Rf2, and is denoted as Rf. In contrast, the resistance of the first resistor Rf1 is not limited to being the same as the resistance of the second resistor Rf2. The resistance of the first resistor Rf1 may be different from the resistance of the second resistor Rf2.

In each of the above embodiments, the high-pass filter 790 includes the filter resistor 787. In contrast, the high-pass filter 790 may include a switched capacitor instead of the filter resistor 787.

In each of the above embodiments, the first adjustment switch 91 is turned on and off in accordance with the inverted-phase signal Sinv. The second adjustment switch 92 is turned on and off in accordance with the modulated signal S. In contrast, the signal for turning the first adjustment switch 91 on and off may be any signal whose frequency is the same as that of the modulated signal S and the inverted-phase signal Sinv, and whose phase is the same as that of the inverted-phase signal Sinv. The signal for turning the second adjustment switch 92 on and off may be any signal whose frequency is the same as that of the modulated signal S and the inverted-phase signal Sinv, and whose phase is the same as that of the modulated signal S.

In the first, third, fourth, and sixth embodiments described above, the first switch 801 is turned on and off in accordance with the modulated signal S. The second switch 802 is turned on and off in accordance with the inverted-phase signal Sinv. The third switch 803 is turned on and off in accordance with the modulated signal S. The fourth switch 804 is turned on and off in accordance with the inverted-phase signal Sinv. In contrast, the signal for turning the first switch 801 on and off may be any signal whose frequency is the same as that of the modulated signal S and the inverted-phase signal Sinv, as long as its phase is the same as that of the modulated signal S. The signal for turning the second switch 802 on and off may be any signal whose frequency is the same as that of the modulated signal S and the inverted-phase signal Sinv, as long as its phase is the same as that of the inverted-phase signal Sinv. The signal for turning the third switch 803 on and off may be any signal whose frequency is the same as that of the modulated signal S and the inverted-phase signal Sinv, as long as its phase is the same as that of the modulated signal S or the inverted-phase signal Sinv. The signal for turning the fourth switch 804 on and off may be any signal whose frequency is the same as that of the modulated signal S and the inverted-phase signal Sinv, as long as its phase is the same as that of the inverted-phase signal Sinv.

In the above second and fifth embodiments, the first switch 801 is turned on and off in accordance with the inverted-phase signal Sinv. The second switch 802 is turned on and off in accordance with the modulated signal S. In contrast, the signal for turning the first switch 801 on and off may be any signal whose frequency is the same as that of the modulated signal S and the inverted-phase signal Sinv, as long as its phase is the same as that of the inverted-phase signal Sinv. The signal for turning the second switch 802 on and off may be any signal whose frequency is the same as that of the modulated signal S and the inverted-phase signal Sinv, as long as its phase is the same as that of the modulated signal S.

In the above second and fifth embodiments, the control unit 85 includes the resistor 856 for the control unit. In contrast, the control unit 85 may include a switched capacitor instead of the resistor 856 for the control unit.

The above embodiments may be combined as appropriate.

What is claimed is:

1. A capacitive sensor detection circuit adapted to a sensor element, the capacitive sensor detection circuit comprising:
a signal generation circuit configured to output a modulated signal to a displaceable electrode of the sensor element, the modulated signal having an input amplitude, a frequency, and a phase;
a fully differential amplifier including
a first input terminal connected to a first electrode of the sensor element, the first electrode configured to output a signal that varies with a change in a first capacitance between the displaceable electrode and the first electrode due to displacement of the displaceable electrode,
a second input terminal connected to a second electrode of the sensor element, the second electrode configured to output a signal that varies with a change in a second capacitance between the displaceable electrode and the second electrode due to the displacement of the displaceable electrode,
a first output terminal configured to output a first output signal that varies with a change in a first input signal and a second input signal, the first input signal being provided to the first input terminal, the second input signal being provided to the second input terminal, and
a second output terminal configured to output a second output signal that varies with a change in the first input signal and the second input signal,
a first feedback capacitor connected to the first input terminal and the first output terminal,
a second feedback capacitor connected to the second input terminal and the second output terminal,
a calculation circuit configured to output a value that correlates with the displacement of the displaceable electrode, based on the first output signal and the second output signal;
a first capacitor connected to a node between the first electrode and the first input terminal,
a second capacitor connected to a node between the second electrode and the second input terminal; and
a controller configured to
acquire the first input signal and the second input signal, each having a frequency and a phase corresponding to the frequency and the phase of the modulated signal, and
output an inverted-phase signal to the first capacitor and the second capacitor based on the first input signal and the second input signal, the inverted-phase signal having
a feedback amplitude that adjusts an amplitude of each of the first input signal and the second input signal towards zero,
a frequency that corresponds to the frequency of the modulated signal, and
a phase that is opposite to the phase of the modulated signal.

2. The capacitive sensor detection circuit according to claim 1, wherein
the controller includes:
a summing circuit configured to acquire a summed signal that correlates with a sum of the first input signal and the second input signal;
a synchronous detection circuit configured to execute demodulation on the summed signal, the demodulation corresponding to the frequency and the phase of the modulated signal; and
a control circuit configured to calculate the feedback amplitude, based on
the summed signal that has been demodulated by the synchronous detection circuit, and
a signal from a reference power supply.

3. The capacitive sensor detection circuit according to claim 2, wherein
the controller includes a high-pass filter that is configured to remove a DC component from the summed signal, and
the synchronous detection circuit is configured to execute the demodulation on the summed signal from which the DC component has been removed by the high-pass filter.

4. The capacitive sensor detection circuit according to claim 2, wherein
the summing circuit includes:
a first voltage follower circuit configured to acquire the first input signal and output a signal that varies with a change in the first input signal;
a first filter capacitor connected to an output terminal of the first voltage follower circuit;
a second voltage follower circuit configured to acquire the second input signal and output a signal that varies with a change in the second input signal;
a second filter capacitor connected to an output terminal of the second voltage follower circuit; and
a junction to which the first filter capacitor and the second filter capacitor are connected, the junction being configured to acquire the summed signal.

5. The capacitive sensor detection circuit according to claim 2, wherein
the synchronous detection circuit includes:
a first switch configured to be turned on and off according to a signal having
a frequency being identical to the frequency of the modulated signal, and
a phase being identical to the phase of the modulated signal;
a second switch configured to be turned on and off according to a signal having
a frequency being identical to the frequency of the modulated signal, and
a phase being opposite to the phase of the modulated signal;
a third switch configured to be turned on and off according to a signal having
a frequency being identical to the frequency of the modulated signal, and
a phase being identical to the phase of the modulated signal; and
a fourth switch configured to be turned on and off according to a signal having
a frequency being identical to the frequency of the modulated signal, and
a phase being opposite to the phase of the modulated signal, and
the control circuit includes:
a transconductance amplifier having
a non-inverting input terminal connected to the second switch and the third switch, and
an inverting input terminal connected to the first switch, the fourth switch, and the reference power supply; and
a capacitor connected to an output terminal of the transconductance amplifier and a ground.

6. The capacitive sensor detection circuit according to claim 2, wherein
the synchronous detection circuit includes:
a first switch configured to be turned on and off based on a signal having
a frequency being identical to the frequency of the modulated signal, and
a phase being opposite to the phase of the modulated signal; and
a second switch configured to be turned on and off based on a signal having
a frequency being identical to the frequency of the modulated signal, and
a phase being identical to the phase of the modulated signal, and
the control circuit includes:
a resistor connected to the first switch and the second switch;
an operational amplifier having
an inverting input terminal connected to the resistor,
a non-inverting input terminal connected to the reference power supply, and
an output terminal; and
a capacitor connected to the inverting input terminal and the output terminal of the operational amplifier.

7. The capacitive sensor detection circuit according to claim 1, further comprising:
a first adjustment capacitor connected to a node between the first electrode and the first input terminal; and
a second adjustment capacitor connected to a node between the second electrode and the second input terminal, wherein
the signal generation circuit is configured to output an inverted-phase signal to the first adjustment capacitor and the second adjustment capacitor, the inverted-phase signal having
an amplitude being identical to the input amplitude of the modulated signal,
a frequency being identical to the frequency of the modulated signal, and
a phase being opposite to the phase of the modulated signal.

8. The capacitive sensor detection circuit according to claim 1, wherein
the fully differential amplifier includes an output common-mode feedback circuit configured to adjust one half of a summed voltage towards a predetermined voltage, the summed voltage correlated with a sum of the first output signal and the second output signal.

9. A capacitive sensor detection circuit adapted to a sensor element, the capacitive sensor detection circuit comprising:
a signal generation circuit configured to output a modulated signal to a displaceable electrode of the sensor element, the modulated signal having an input amplitude, a frequency, and a phase;
a fully differential amplifier including
a first input terminal connected to a first electrode of the sensor element, the first electrode configured to output a signal that varies with a change in a first capacitance between the displaceable electrode and the first electrode due to displacement of the displaceable electrode,
a second input terminal connected to a second electrode of the sensor element, the second electrode configured to output a signal that varies with a change in a second capacitance between the displaceable electrode and the second electrode due to the displacement of the displaceable electrode,
a first output terminal configured to output a first output signal that varies with a change in a first input signal and a second input signal, the first input signal being provided to the first input terminal, the second input signal being provided to the second input terminal, and
a second output terminal configured to output a second output signal that varies with a change in the first input signal and the second input signal;
a first feedback capacitor connected to the first input terminal and the first output terminal;
a second feedback capacitor connected to the second input terminal and the second output terminal;
a calculation circuit configured to output a value that correlates with the displacement of the displaceable electrode, based on the first output signal and the second output signal;
a first capacitor connected to a node between the first electrode and the first input terminal;
a second capacitor connected to a node between the second electrode and the second input terminal; and
a controller configured to
acquire the first output signal and the second output signal, each having a frequency and a phase corresponding to the frequency and the phase of the modulated signal, and
output an inverted-phase signal to the first capacitor and the second capacitor based on the first output signal and the second output signal, the inverted-phase signal having
a feedback amplitude that adjusts an amplitude of each of the first output signal and the second output signal towards zero,
a frequency that corresponds to the frequency of the modulated signal, and
a phase that is opposite to the phase of the modulated signal.

10. The capacitive sensor detection circuit according to claim 9, wherein
the controller includes:
a summing circuit configured to acquire a summed signal that correlates with a sum of the first output signal and the second output signal;
a synchronous detection circuit configured to execute demodulation on the summed signal, the demodulation corresponding to the frequency and the phase of the modulated signal; and
a control circuit configured to calculate the feedback amplitude, based on
the summed signal that has been demodulated by the synchronous detection circuit, and
a signal from a reference power supply.

11. The capacitive sensor detection circuit according to claim 10, wherein
the controller includes a high-pass filter that is configured to remove a DC component from the summed signal, and
the synchronous detection circuit is configured to execute the demodulation on the summed signal from which the DC component has been removed by the high-pass filter.

12. The capacitive sensor detection circuit according to claim 10, wherein
the summing circuit includes:
a first voltage follower circuit configured to acquire the first output signal and output a signal that varies with a change in the first output signal;
a first filter capacitor connected to an output terminal of the first voltage follower circuit;
a second voltage follower circuit configured to acquire the second output signal and output a signal that varies with a change in the second output signal;
a second filter capacitor connected to an output terminal of the second voltage follower circuit; and
a junction to which the first filter capacitor and the second filter capacitor are connected, the junction being configured to acquire the summed signal.

13. The capacitive sensor detection circuit according to claim 10, wherein
the synchronous detection circuit includes:
a first switch configured to be turned on and off according to a signal having
a frequency being identical to the frequency of the modulated signal, and
a phase being identical to the phase of the modulated signal;
a second switch configured to be turned on and off according to a signal having
a frequency being identical to the frequency of the modulated signal, and
a phase being opposite to the phase of the modulated signal;
a third switch configured to be turned on and off according to a signal having
a frequency being identical to the frequency of the modulated signal, and
a phase being identical to the phase of the modulated signal; and
a fourth switch configured to be turned on and off according to a signal having
a frequency being identical to the frequency of the modulated signal, and
a phase being opposite to the phase of the modulated signal, and
the control circuit includes:
a transconductance amplifier having
a non-inverting input terminal connected to the second switch and the third switch, and
an inverting input terminal connected to the first switch, the fourth switch, and the reference power supply; and
a capacitor connected to an output terminal of the transconductance amplifier and a ground.

14. The capacitive sensor detection circuit according to claim 10, wherein
the synchronous detection circuit includes:
a first switch configured to be turned on and off based on a signal having
a frequency being identical to the frequency of the modulated signal, and
a phase being opposite to the phase of the modulated signal; and
a second switch configured to be turned on and off based on a signal having
a frequency being identical to the frequency of the modulated signal, and
a phase being identical to the phase of the modulated signal, and
the control circuit includes:
a resistor connected to the first switch and the second switch;
an operational amplifier having
an inverting input terminal connected to the resistor,
a non-inverting input terminal connected to the reference power supply, and
an output terminal; and
a capacitor connected to the inverting input terminal and the output terminal of the operational amplifier.

15. The capacitive sensor detection circuit according to claim 9, further comprising:
a first adjustment capacitor connected to a node between the first electrode and the first input terminal; and
a second adjustment capacitor connected to a node between the second electrode and the second input terminal, wherein
the signal generation circuit is configured to output an inverted-phase signal to the first adjustment capacitor and the second adjustment capacitor, the inverted-phase signal having
an amplitude being identical to the input amplitude of the modulated signal,
a frequency being identical to the frequency of the modulated signal, and
a phase being opposite to the phase of the modulated signal.

16. The capacitive sensor detection circuit according to claim 9, wherein
the fully differential amplifier includes an input common-mode feedback circuit configured to adjust one half of a summed voltage towards a predetermined voltage, the summed voltage correlated with a sum of the first input signal and the second input signal.
